(19) United States
(12) Patent Application Publication
(10) Pub. No.: US 2020/0314227 A1
(43) Pub. Date: Oct. 1, 2020

(54) METHOD AND APPARATUS FOR PROCESSING TELEPHONE CALLS IN CONJUNCTION WITH CALL BLOCKING SERVICE

(71) Applicant: Call Silencer Inc., Sudbury, MA (US)

(72) Inventors: N. Scott Bradley, Nahant, MA (US); Joseph Randolph, Winchester, MA (US)

(21) Appl. No.: 16/363,473

(22) Filed: Mar. 25, 2019

(51) Int. Cl. H04M 1/654; H04M 3/42; H04M 1/663; H04M 1/57

(52) U.S. Cl. CPC H04M 1/654; H04M 1/576; H04M 1/663; H04M 3/42059

(57) ABSTRACT

Methods and systems are disclosed for blocking unwanted telephone calls utilizing a ring blocking device that works in conjunction with an external remote call blocking service. The call blocking service blocks unwanted calls by examining the caller ID information that is normally transmitted to a wireline telephone device during the silent interval between the first and second power ringing bursts of the call. The call blocking service compares the caller ID information to a blacklist of unwanted calling parties and ends the call if the incoming call's caller ID information matches an entry on the blacklist. The ring blocking device, which is typically located on the user premises, is configured to prevent the first power ringing burst from activating the telephone ringer, while also ensuring that the telephone reliably receives and displays the caller ID.

### BACKGROUND

The present application relates generally to methods and systems for blocking unwanted telephone calls made to wireline telephones and other telephone terminal devices.

In recent years, unwanted telephone calls, including telemarketing calls, phone scams, and robocalls have become an increasing problem for both residential and business telephone users.

A common strategy for automatically blocking such calls is to examine the caller identification (caller ID or CID) information of the calling party and compare it to a blacklist of unwanted callers. When the caller ID of a calling party matches an entry on the blacklist, the call is either blocked entirely or ended by automatically answering the call then hanging up immediately.

Examples of known call blocking services include devices that reside on the user premises and maintain an internal blacklist that is updated by the user. One drawback of such systems is that the user must continuously update the blacklist, e.g., in response to having received an unwanted call. Another drawback is that such systems do not block the first ring of an unwanted call since the caller ID information, which must be examined, is ordinarily received after the first ring.

Some known devices block the first ring of every incoming call. The caller ID information is examined during the silent interval after the first ring, and compared to a blacklist. Based on this comparison, a decision is made regarding whether to end the call or allow subsequent power ringing bursts to pass through to the telephone.

Telemarketers have responded to the spread of such devices by making frequent changes to the caller ID information associated with their telephone calls. This method of “caller ID spoofing” has become easier to implement with the increased use of telephone calls over the Internet, where the calling party can more easily alter the caller ID information associated with the call. As a result, it has become increasingly difficult for individual users to keep their blacklist up to date.

To help address the problem of keeping the blacklist up to date, some companies, e.g., Nomorobo, provide a centralized call blocking service remote from users' telephones that actively maintains and updates a large database of known telemarketer caller IDs. This database is maintained on a centralized server. Users who wish to use such a call blocking service configure their telephone line using an available system that simultaneously calls both the user's telephone number and a number at the call blocking service when a call comes in to the user's telephone line. Using this simultaneous ringing feature, both the ring signal and the caller ID information are simultaneously transmitted to both the user's telephone line and to the call blocking service server.

When the caller ID information is presented after the first ring, the call blocking service compares the caller ID information to their database of blacklisted numbers. If the caller ID information matches an entry in the call blocking service blacklist, the system automatically ends the call, e.g., by briefly answering the call and then hanging up. At the user site, the user will still hear one ring burst and will see the caller ID information for the blocked call.

Many users of such call blocking services have complained that for blocked calls, they do not want to hear the first ring burst. The call blocking services cannot provide this feature, since the call blocking service must wait until it sees the caller ID information, which is only delivered after the first ring.

One possible solution to avoid receiving the first ring would be to use an additional ring blocking device connected to the user's telephone line that simply blocks the first ring of every call. However, this solution has multiple problems. First, many caller ID detectors will not display a caller ID signal that is not immediately preceded by a power ringing burst. Since the ring blocking device blocks the first ring of every call, rather than just the calls that were blocked by a call blocking service, these caller ID detectors will not display the caller ID information associated with calls that the call blocking service did not block.

The second problem is that unless the ring blocking device has a very fast response time for blocking the first ring burst, some telephone devices will still detect the truncated ring burst and generate an unwanted ringer response.

The third problem arises from the fact that many known ring blocking devices are powered entirely by the power available from the telephone line. FCC Part 68 regulations for equipment connected to a telephone line place strict limits on the amount of DC current that can be drawn from the telephone line when the telephone line is in the idle state. Generally stated, FCC Part 68 requires that any device connected to the telephone line must present a minimum DC resistance of 5 megohms (five million Ohms) for test voltages of up to 100 Vdc. For a typical telephone line voltage of 50 Vdc, this translates to a maximum allowable DC current of only 10 uA.

In a sampling of certain currently available telephone line-powered ring blocking devices that were evaluated for this on-hook DC current rule, all were found to greatly exceed the allowable limit, including at least one product that was explicitly labeled as being compliant with FCC Part 68.

Technically, compliance with FCC Part 68 is legally required in the United States, but in recent years, FCC Part 68 compliance has been only sporadically enforced. This has allowed many non-compliant devices to be sold in the United States. Selling a non-compliant device represents a potential legal exposure, especially for large retailers that might become an attractive target for FCC Part 68 enforcement action.

Accordingly, there is a need in the art for an improved ring blocking apparatus that, when used in conjunction with Nomorobo or other call blocking service, overcomes one or more of the limitations described above for existing ring blocking methods and devices.

### BRIEF SUMMARY OF THE DISCLOSURE

In accordance with one or more embodiments, a method is disclosed for processing a telephone call to Plain Old Telephone Service (POTS) telephone terminal equipment. The telephone call includes caller identification (caller ID) information. The telephone call is simultaneously received at a call blocking service and a ring blocker device associated with the POTS telephone terminal equipment. The call blocking service analyzes the caller ID information of the telephone call to determine if the telephone call is unwanted and ends the telephone call if the telephone call is determined to be unwanted. The ring blocker device associated with the POTS telephone terminal equipment processes the telephone call by: (i) blocking a first power ringing burst of the telephone call from reaching the POTS telephone terminal equipment; (ii) capturing and storing the caller ID information of the telephone call present in a silent interval between the first power ringing burst and a subsequent second power ringing burst; (iii) allowing the second power ringing burst of the telephone call to pass to the POTS telephone terminal equipment when the telephone call is not ended by the call blocking service; and (iv) transmitting the caller ID information captured and stored in step (ii) to the POTS telephone terminal equipment after the second power ringing burst to enable the caller ID information to be displayed to a user of the POTS telephone terminal equipment.

In accordance with one or more embodiments, a ring blocker device is disclosed. The ring blocker device is associated with Plain Old Telephone Service (POTS) telephone terminal equipment for processing a telephone call directed to the POTS telephone terminal equipment. The telephone call includes caller identification (caller ID) information and is received simultaneously at the ring blocker device and a call blocking service, which analyzes the caller ID information of the telephone call to determine if the telephone call is unwanted and ends the telephone call if the telephone call is determined to be unwanted. The ring blocker device comprises: a telephone line input port for receiving the telephone call, a telephone line output port connectable to the POTS telephone terminal equipment, and at least one processor for processing the telephone call received at the telephone line input port. The at least one processor is configured to: (i) block a first power ringing burst of the telephone call from reaching the POTS telephone terminal equipment; (ii) capture and store the caller ID information of the telephone call present in a silent interval between the first power ringing burst and a subsequent second power ringing burst; (iii) allow the second power ringing burst of the telephone call to pass to the POTS telephone terminal equipment from the telephone line output port when the telephone call is not ended by the call blocking service; and (iv) transmit the caller ID information captured and stored in step (ii) to the POTS telephone terminal equipment through the telephone line output port after the second power ringing burst to enable the caller ID information to be displayed to a user of the POTS telephone terminal equipment.

### BRIEF DESCRIPTION OF THE DRAWINGS

FIG. 1 is a simplified diagram illustrating an exemplary telephone call processing system including a ring blocker device and a call blocking service in accordance with one or more embodiments.

FIG. 2 is a perspective view of an exemplary ring blocker in accordance with one or more embodiments.

FIG. 3A is a simplified diagram illustrating the standard timing used in most countries for delivering caller ID information on an incoming telephone call.

FIG. 3B is a simplified diagram illustrating an exemplary modified signal delivered to a telephone device in which the first ring burst is blocked and the caller ID information is relocated between the second and third ring bursts in accordance with one or more embodiments.

FIG. 4 is a simplified circuit diagram illustrating select components of an exemplary ring blocker device having an internal battery to allow compliance with FCC Part 68 limitations on the amount of DC current that can be drawn from a telephone line when the telephone is in the on-hook state in accordance with one or more embodiments.

FIG. 5 is a simplified circuit diagram of an alternate exemplary ring blocker device powered entirely from the telephone line, yet still in compliance with FCC Part 68 limitations in accordance with one or more embodiments.

FIG. 6 is a simplified diagram showing an exemplary installation location for the ring blocker device at the single-point service entrance for the analog wireline telephone service in accordance with one or more embodiments.

FIG. 7 is a simplified diagram showing an alternate exemplary installation locations for ring blocker devices in series with each telephone in accordance with one or more embodiments.

FIG. 8 is a simplified flowchart illustrating exemplary processing of a telephone call by the ring blocker device and a call blocking service in accordance with one or more embodiments.

FIG. 9 is a simplified flowchart illustrating an exemplary call processing method implemented in a ring blocker device in accordance with one or more embodiments.

### DETAILED DESCRIPTION

Various embodiments disclosed herein relate to methods and systems for blocking unwanted telephone calls utilizing a ring blocking device that works in conjunction with an external remote call blocking service like Nomorobo. The call blocking service blocks unwanted calls by examining the caller ID information that is normally transmitted to a wireline telephone device during the silent interval between the first and second power ringing bursts of the call. The call blocking service compares the caller ID information to a blacklist of unwanted calling parties and ends the call if the incoming call's caller ID information matches an entry on the blacklist. The ring blocking device, which is typically located on the user premises, is configured to prevent the first ring burst from activating the telephone ringer, while also ensuring that the telephone reliably receives and displays the caller ID information. Users of call blocking services thus will not hear the first ring of calls blocked by the system, and will also receive caller ID information for calls that are not blocked.

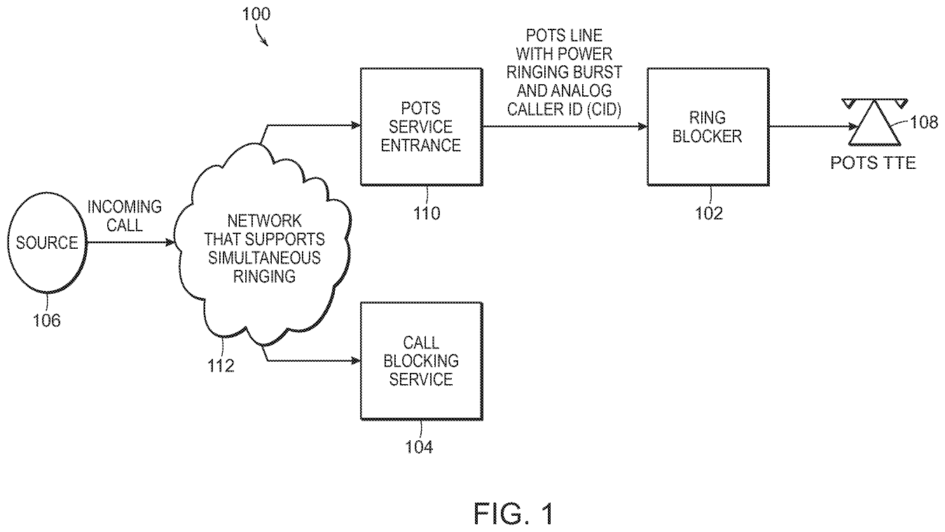

FIG. 1 is a simplified diagram illustrating an exemplary telephone call processing system 100 in accordance with one or more embodiments. The system 100 includes a ring blocker 102 and a call blocking service 104. The ring blocker 102 is connected between the source 106 of an incoming call and the telephone terminal equipment 108 at the receiving end of the call.

For convenience, the telephone terminal equipment 108 is graphically represented as a single telephone device, but in practice element 108 can be any device (or combination of devices) that is capable of receiving Plain Old Telephone Service (POTS) signals. A POTS communication link uses analog signals to transfer voice signals and also uses analog signals to transfer caller ID data. To ring a telephone, a POTS line applies a power ringing burst of typically 40 to 90 Vrms at 20 Hz. A typical cadence for the power ringing burst is a repeating pattern of 2000 ms on followed by 4000 ms off, although other cadences are sometimes used. Examples of POTS terminal devices include telephones (with or without a built-in caller ID display), stand-alone caller ID receivers, answering machines, and any other device that has provisions for receiving POTS signals. Such devices are generally referred to herein as POTS telephone terminal equipment (POTS TTE).

As represented in FIG. 1, source 106 of the incoming call is an intermediate point in the overall connection. The actual originating point for the call can be any communications device that is capable, either directly or indirectly, of placing a call to a POTS telephone. Such calls can originate from a wide range of possible locations, including POTS telephones, digital telephones, cellular telephones, internet callers, and computerized calling equipment. The incoming call is directed to the POTS TTE 108, and is also routed to a call blocking service 104 that compares the caller ID of the incoming call to a blacklist of unwanted callers.

The call blocking service 104 can be any centralized call blocking service that is able to block unwanted calls. For instance, the system 104 maintains and updates a blacklist of caller ID information of known unwanted callers and blocks calls based on the blacklist. Nomorobo is one example of a call blocking service suitable for use with the ring blocker device 102, but other services having similar functionality can also be used. If the caller ID information associated with the incoming call is not on the blacklist, the call blocking service 104 takes no action. However, if the caller ID information associated with the incoming call matches an entry on the blacklist, call blocking service 104 ends the call. Unwanted calls can be ended by the call blocking service in various ways including, e.g., by answering the call and then hanging up immediately. For calls ended by call blocking service 104, only the first power ringing burst and the subsequent caller ID information arrive at the POTS service entrance 110.

The signals presented at source 106, call blocking service 104, and the POTS service entrance 110 can be in either analog or digital form, and do not have to use the same communication protocol or transmission medium. The transmission medium can be comprised of any transmission medium (or combination thereof) including, but not limited to, wireline, wireless, fiber, coax, and internet. In FIG. 1, network 112 represents any combination of public or private networks that is capable of implementing the simultaneous ring feature offered by many network service providers.

Regardless of the specific path taken thus far for the call, a transition takes place at the POTS service entrance 110. At this point, the incoming call is converted to a POTS wireline signal.

The conversion to POTS is not necessary if the incoming signal at the POTS service entrance 110 is already in the POTS format. For traditional land line POTS service, the service entrance is simply the place where the outside POTS telephone line enters the building.

In recent years, it has become more common for the telephone service to be brought to the building in some format other than POTS, such as digital service over fiber, coax, or wireless. In such cases, the POTS service entrance 110 converts the incoming signal to POTS. The POTS service entrance 110 can then physically located anywhere in the building, provided that it has access to the incoming signal.

The ring blocker device 102 is inserted in series between the POTS service entrance 110 and the destination POTS TTE 108.

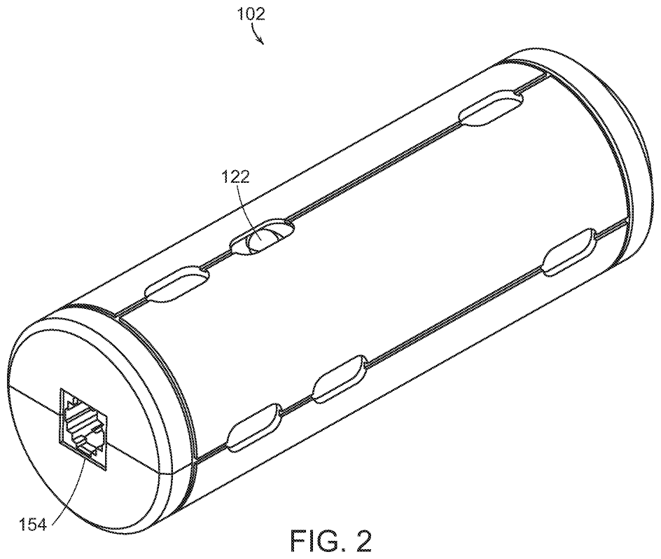

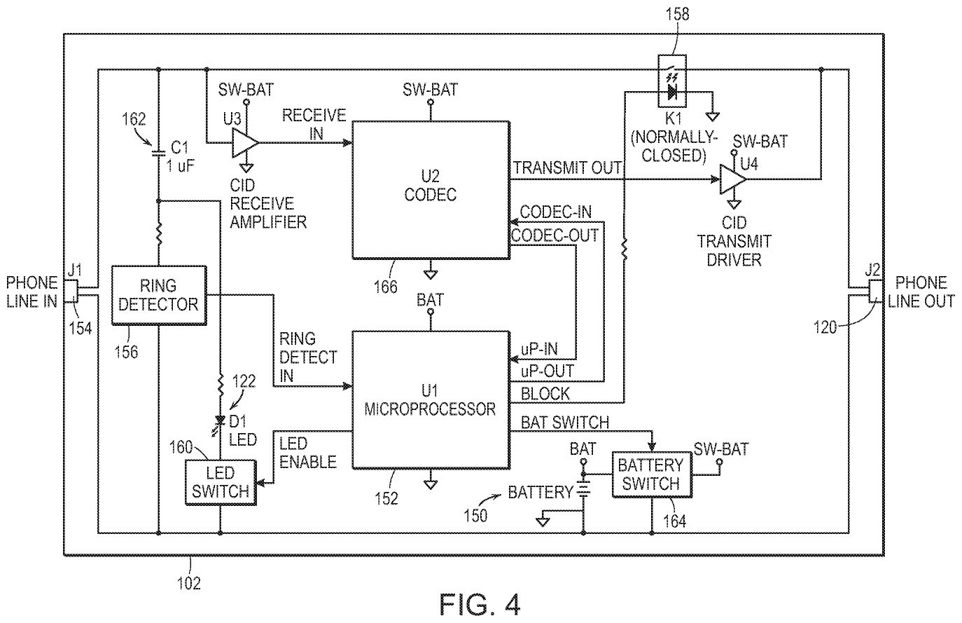

FIG. 2 is a perspective view of an exemplary ring blocker device 102 in accordance with one or more embodiments. The ring blocker device 102 includes a telephone line input port 154 for receiving analog wireline POTS telephone signals and a telephone line output port (not visible in FIG. 2, but depicted in FIG. 4 by reference number 120) connected to the telephone 108 or other POTS TTE. The ring blocker device 102 also includes a light emitting diode (LED) 122 for providing a visual indication to the user when a power ringing burst is being blocked.

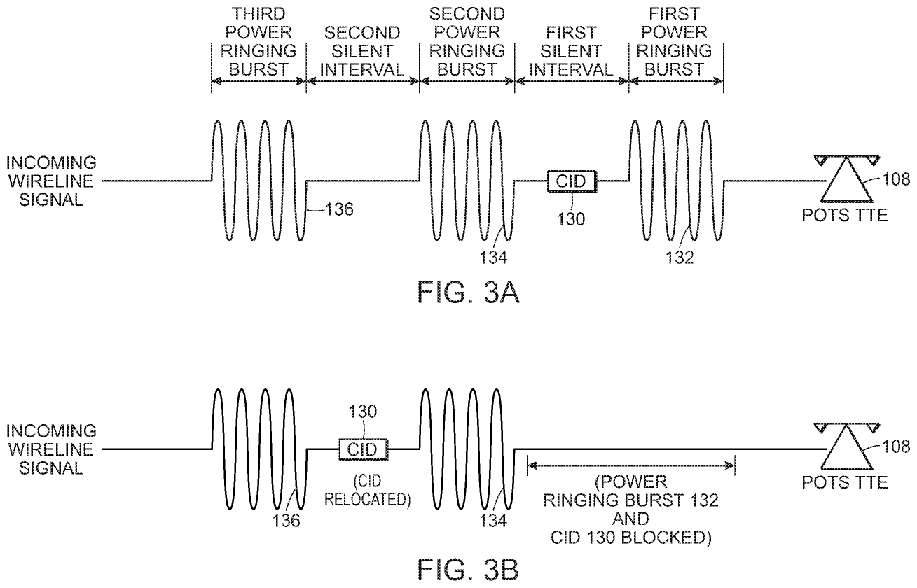

FIG. 3A shows the timing for the standard caller ID delivery method used for POTS telephones in the United States. The caller ID information 130 is presented during the silent interval between the first power ringing burst 132 and the second power ringing burst 134. The caller ID information is delivered using a modulated Frequency Shift Keying (FSK) signal transmitted within the telephone's 300 Hz to 3400 Hz analog audio voice band.

The US and most other countries worldwide use the general signaling scheme shown in FIG. 3A, where the repeating pattern consists of a single ring burst of typically one to three seconds, followed by a single silent interval of typically three to five seconds. In some countries (e.g., the UK), the repeating pattern contains a double-ring of 400 ms on, 200 ms off, 400 ms on, 2000 ms off. Furthermore, in the US and some other countries, “distinctive ringing” services are available where the initial 2000 ms ring burst is divided into two or more short bursts of various durations. One application of these distinctive ring patterns is to provide an indication of the origin of the call. Another application is for cases where two or more phone numbers have been assigned to the same physical phone line. The distinctive ring patterns can provide an indication of the specific phone number that was called. For all of these cases, though, the caller ID information is sent during the final, long silent interval of the repeated pattern. As used herein, the term “power ringing burst” is intended to include single and multiple ring bursts in the repeating pattern.

While the caller ID information is typically sent during the final, long silent interval of the first power ringing burst, the specific frequencies used for the FSK modulation can differ, and the format of the encoded digital data in the caller ID message can also differ.

FIG. 3B shows how ring blocker device 102 alters the input signals that are received by the connected POTS TTE 108. The first power ringing burst 132 is blocked, preferably with a response time of less than 25 ms so that the let-through portion of the first power ringing burst 132 is too short to trigger any amount of sound from the ringer of the associated telephone 108. During the first silent interval, the caller ID data 130 is captured and stored within ring blocker device 102, while also being blocked from delivery to the POTS TTE 108. During the second silent interval between power ringing burst 134 and power ringing burst 136, the captured caller ID information 130 is transmitted to the associated POTS TTE 108.

When viewed from the perspective of the associated POTS TTE 108, the timing of the received power ringing burst and caller ID signal are generally identical to the standard format shown in FIG. 3A. Since the resulting timing matches the standard timing, any caller ID detection device that operates correctly with the standard timing will also operate correctly with the altered signal delivered by ring blocker device 102.

It should be noted that capture-and-transmit of the caller ID information does not require that the caller ID FSK signals be demodulated when received by the ring blocker device, and then remodulated when transmitted by the ring blocker device. While this is an acceptable way to accomplish the capture-and-transmit, an alternative approach is to simply record the FSK modulated caller ID information packet, and then transmit, i.e., replay, the recorded copy.

This alternative approach reduces the cost of the ring blocker device, and it has the additional benefit of being compatible with any other caller ID delivery system that transmits FSK signals during the first silent interval. Since the FSK signal is simply being recorded and transmitted, there is no need to be concerned with the specific frequencies used in the FSK modulation, and no need to be concerned with the specific format used for the analog encoded digital data in the caller ID information packet.

FIG. 4 is a circuit diagram illustrating functional components of an exemplary ring blocker device 102 in accordance with one or more embodiments. The ring blocker device 102 includes an internal battery 150 to simplify the task of complying with the FCC Part 68 limit on DC current drawn from the telephone line when the telephone line is idle. Battery 150 eliminates the need to draw any DC current from the phone line when the phone line is in the idle state. While the amount of DC current that can be drawn from the phone line is very small, a much larger AC current is permitted while a power ringing burst is applied. During the application of a power ringing burst, FCC Part 68 allows the ring blocker device 102 to present an AC impedance of as low as 1400 ohms. Even for an applied power ringing burst of 40 Vrms, this allows the ring blocker device to draw approximately 29 mA of AC rms current from the telephone line.

Capacitor 162 and LED switch 160 allow the energy from the power ringing burst to be used to power LED indicator 122, thereby conserving battery power. Battery 150 is used to keep microprocessor 152 in a powered-up standby mode when the ring blocker device 102 is not active, which helps provide a fast response to the ring blocking function. Battery 150 is also used to power the remaining functions of blocking the first power ringing burst and performing the capture and transmit of the caller ID information. The very small amount of current required from the battery 150 during these brief intervals can allow a small lithium coin cell battery such as a CR2032 to power the ring blocker device 102 for an extended period of time, e.g., more than one year, without needing battery replacement.

In the embodiment shown in FIG. 4, only the microprocessor 152 is powered by the battery 150 when ring blocker device 102 is in the idle mode. When ring blocker device 102 is in the idle mode, microprocessor 152 is held in a low power standby mode to minimize the current drain on the battery 150. When a first power ringing burst is applied at the telephone line input jack 154, the ring detector 156 wakes up microprocessor 152. Microprocessor 152 responds by immediately opening switch 158 to block the power ringing burst, and then closing the LED switch 160 so that the power ringing burst coupled through capacitor 162 will cause LED 122 to illuminate. This is used to provide a visual indication to the user that a power ringing burst is being blocked.

After the applied power ringing burst ends, microprocessor 152 turns the LED switch 160 off and uses the Battery Switch 164 to apply power to codec 166, receive amplifier U3, and transmit driver U4. Microprocessor 152 uses codec 166 to digitize, capture, and store the FSK caller ID signal that appears during the first silent interval. Note that once the caller ID signal is digitized by codec 166, microprocessor 152 can either store the digital samples directly as an audio recording of the FSK caller ID signal, or demodulate the FSK signal to recover the encoded digital data of the caller ID FSK signal. Switch 158 is held in the open state until the caller ID FSK signal has been captured, so that the FSK signal is blocked from delivery to the POTS TTE 108. At this point switch 158 is released and returns to its normally closed state.

When the second power ringing burst 134 arrives, microprocessor 152 takes no action. LED 122 remains off and switch 158 is left in its normally-closed state. After the second power ringing burst 134 ends, microprocessor 152 uses codec 166 to transmit the captured and saved caller ID signal 130 during the second silent interval. Note that the transmitted caller ID signal can be either a digital recording of the original caller ID FSK signal, or, if the original caller ID FSK signal was demodulated for local storage, it can be remodulated back into its original FSK form.

For clarity, codec 166 has been shown as a component that is separate from microprocessor 152. As is well known in the art, the functions of a codec include an analog-to-digital converter (ADC) and a digital-to-analog converter (DAC). However, in recent years, microprocessors have increasingly been equipped with built-in ADC and DAC functions. It will be obvious to a person of ordinary skill in the art that some or all of the codec function 166 could alternatively be incorporated into microprocessor 152.

Microprocessor 152 maintains an internal timer to determine whether subsequent power ringing bursts represent additional power ringing bursts from the same call, or, alternatively, represent the first power ringing burst of a new call. Since the duration of a typical silent interval is about four seconds, a power ringing burst that arrives after a silent interval of greater than six seconds typically represents the first power ringing burst of a new call.

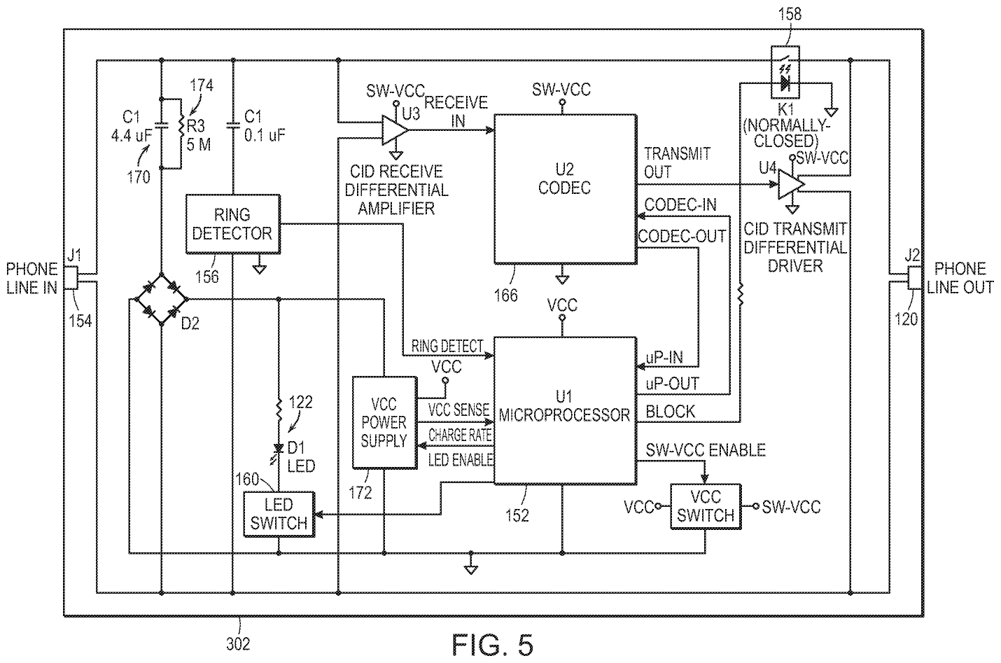

FIG. 5 shows a circuit diagram of an exemplary ring blocker device 302 in accordance with one or more embodiments, which is entirely powered from the telephone line, while still meeting the DC current limitations of FCC Part 68. This version may be more expensive than the ring blocker device 102 of FIG. 4, due to the need to strictly manage the DC current drawn from the telephone line. However, this embodiment has the advantage of not requiring a battery.

For the embodiment shown in FIG. 5, the sequence of steps used to block the first power ringing burst, capture the caller ID FSK, and then transmit the caller ID FSK are all generally identical to the embodiment in FIG. 4. The key difference is that the battery 150 has been replaced by VCC power supply 172. VCC power supply 172 contains one or more charge storage capacitors and a voltage regulator. Available current from the telephone line is directed to the charge storage capacitor(s) in the VCC power supply, and the stored charge is used to power the circuit during the first and second silent intervals.

To increase the available telephone line power while still meeting the limitations imposed by FCC Part 68, two modifications are made. First, the value of capacitor 170 is increased to 4.4 uF to couple as much as possible of the power ringing burst into the VCC power supply 172. Second, a 5 megohm resistor 174 is placed across capacitor 170 to draw the maximum allowable DC current from the telephone line.

Together these two modifications provide complimentary sources of charge current to the VCC power supply 172. While a power ringing burst is being applied on the telephone line, there is more charge coupled through capacitor 170 than is actually needed to operate the circuit. The surplus charge is stored in the VCC power supply 172 and then used to power the circuit during the first and second silent intervals. In the idle state, only microprocessor 152 remains powered, and is held in a low power standby mode.

In the standby mode, microprocessor 152 consumes less than the 10 uA DC that is available via resistor 174. This allows the VCC power supply 172 to keep its internal storage capacitor(s) charged during long periods of having no power ringing bursts applied. The primary benefit of maintaining this pre-charge is a faster response time for blocking the first power ringing burst.

Without the small current provided by resistor 174, the charge on the storage capacitor(s) in the VCC power supply 172 would slowly leak down to zero if no power ringing bursts were applied for a long time. With the storage capacitor in the VCC power supply 172 initially at zero volts when the first power ring burst is applied, the required charging time would result in a slower response time for blocking the first power ringing burst. Fast response time is important because any portion of the first power ringing burst that is not blocked can result in spurious triggering of the audible ring tone from POTS TTE 108.

Note that the VCC power supply 172 also has an output called VCC SENSE and an input called CHARGE RATE. This allows microprocessor 152 to monitor the charge on the internal storage capacitor(s) in the VCC power supply 172, and to respond by altering the charging circuit for the capacitor(s). This capability can be used to further reduce the response time for blocking the first power ringing burst.

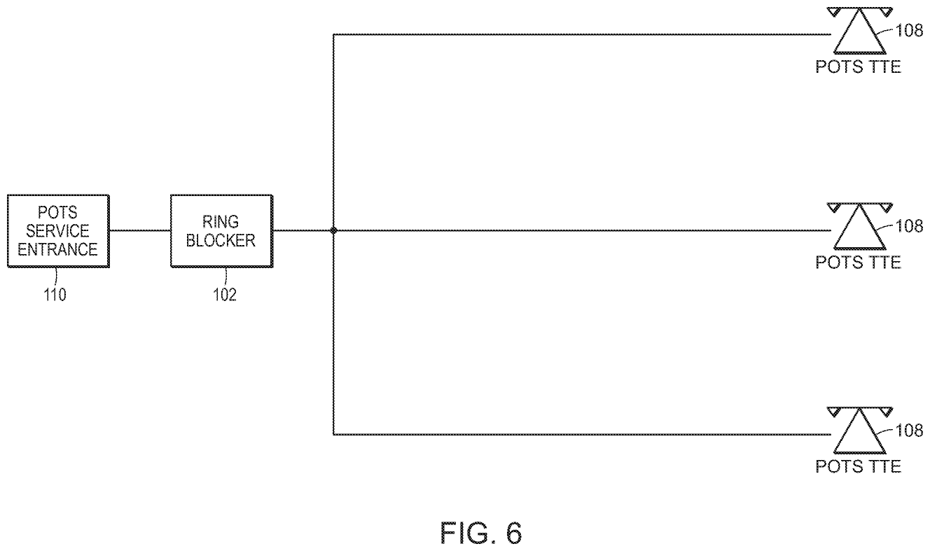

FIG. 6 shows the preferred location for installing ring blocker device 102. The preferred location for ring blocker device 102 is near the POTS service entrance 110, where a single ring blocker device can perform the ring blocking function for all POTS TTE 108 connected to the telephone line.

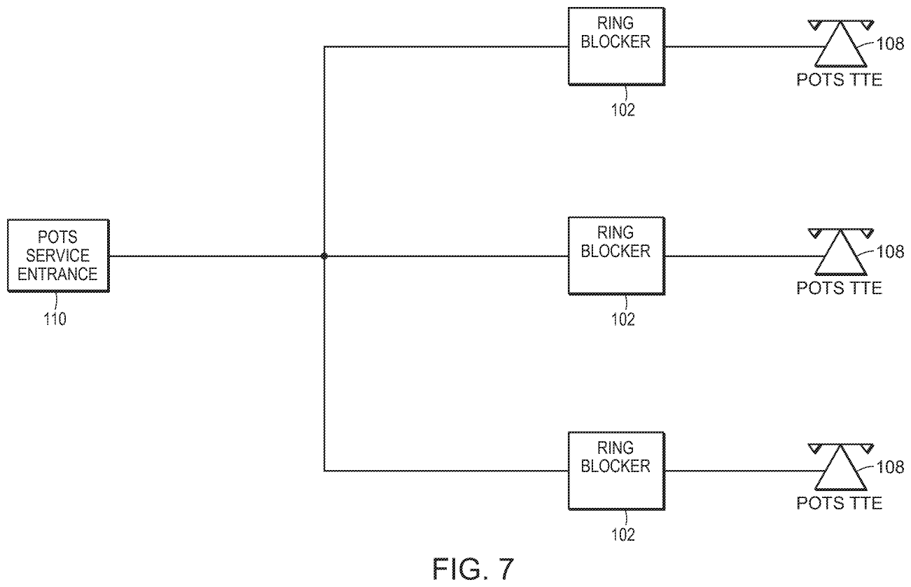

FIG. 7 shows an alternate configuration that does not require installing ring blocker device 102 at the service entrance. In this configuration, a separate ring blocker device 102 is installed locally in series with every POTS TTE 108. The performance of this alternate configuration is the same as the configuration shown in FIG. 6, but the overall cost of the configuration in FIG. 7 is higher. One benefit obtained with the configuration of FIG. 7 is that it is not necessary to determine the physical location of the service entrance 110 and install ring blocker device 102 near the service entrance 110. In some buildings, the service entrance may be in a hard to access location such as a basement or closet.

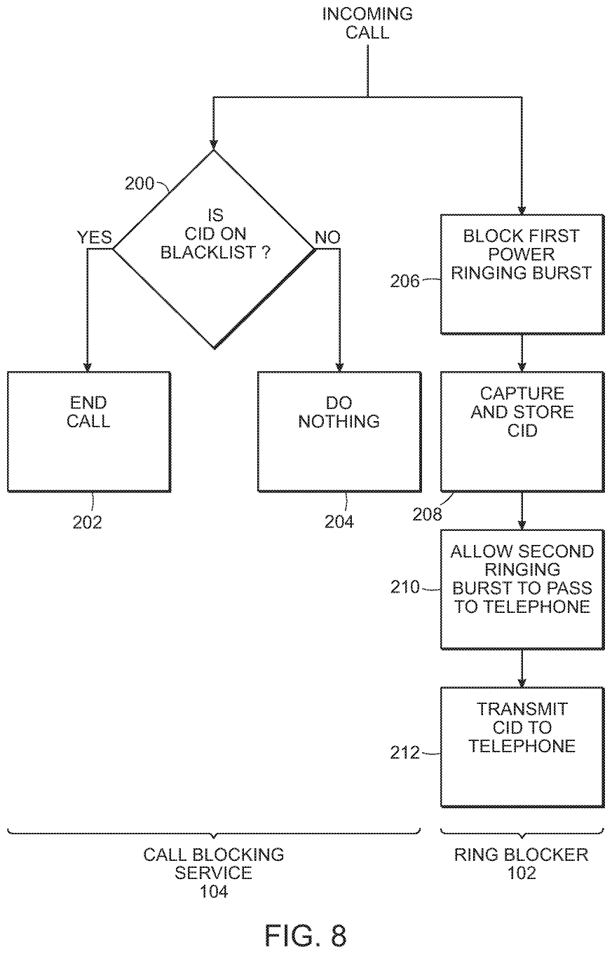

FIG. 8 is a simplified flowchart illustrating exemplary processing of a telephone call by the ring blocker device and a call blocking service in accordance with one or more embodiments. An incoming telephone call is simultaneously received at a call blocking service 104 and a ring blocker device 102 associated with the POTS TTE 108.

At step 200, the call blocking service 104 analyzes the caller ID information of the telephone call to determine if the telephone call is unwanted. If so the call is ended at step 202. If not, the call blocking service 104 takes no further action at 204.

At step 206, the ring blocker device 102 blocks a first power ringing burst 132 and caller ID information 130 of the telephone call from reaching POTS TTE 108. At step 208, the ring blocker device 102 captures and stores the caller ID information 130 of the telephone call present in a silent interval between the first power ringing burst 132 and a subsequent second power ringing burst 134. At step 210, the ring blocker device 102 checks for a second power ringing burst of the telephone call. The arrival of a second power ring burst indicates that the call was not ended by the call blocking service 104, so ring blocker device 102 allows the second power ringing burst to pass to POTS TTE 108. At step 212, the ring blocker device 102 transmits the captured and stored caller ID information 130 to POTS TTE 108 after the second power ringing burst to enable the caller ID information to be displayed to a user POTS TTE 108.

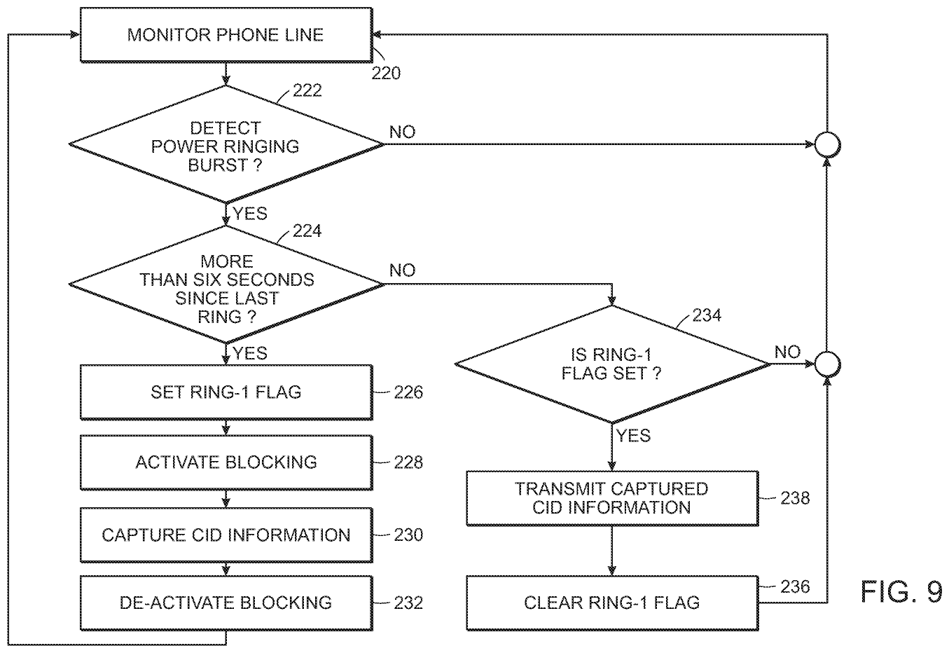

FIG. 9 is a simplified flowchart illustrating an exemplary call processing method implemented in the ring blocker device 102 in accordance with one or more embodiments. Ring blocker device 102 monitors the input signal applied at the phone line input jack 154 at 220. When a power ringing burst is detected at 222, a decision is made at 224 on whether the power ringing burst represents the first power ringing burst of a new call, or just a subsequent power ringing burst of an existing call. If the preceding silent interval was longer than six seconds, the detected power ringing burst is presumed to be the first power ringing burst of a new call. In this case, the RING-1 flag is set at 226 and ring blocker 102 proceeds to block the ring at 228 and capture the caller ID information at 230. Following this, ring blocker device 102 deactivates blocking at 232 and returns to monitoring for a power ring burst.

If the next power ringing burst arrives after a silent interval of less than six seconds and the RING-1 flag is determined to be set at 234, that power ringing burst is presumed to be a subsequent power ring burst from the same call. This causes the RING-1 flag to be cleared at 236 and the captured caller ID information to be transmitted during the next silent interval at 238.

For all subsequent power ringing bursts of the same call (those that arrive after a silent interval of less than six seconds), ring blocker device 102 takes no action.

The processes of the ring blocker device described above may be implemented in software, hardware, firmware, or any combination thereof. The processes are preferably implemented in one or more computer programs executing on the microprocessor. Each computer program can be a set of instructions (program code) in a code module resident in ring blocker device 102. Until required by the microprocessor, the set of instructions may be stored in another computer memory or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

1. A method of processing a telephone call to Plain Old Telephone Service (POTS) telephone terminal equipment, the telephone call including caller identification (caller ID) information, the telephone call being simultaneously received at a call blocking service and a ring blocker device associated with the POTS telephone terminal equipment, wherein the call blocking service analyzes the caller ID information of the telephone call to determine if the telephone call is unwanted and ends the telephone call if the telephone call is determined to be unwanted, wherein the method comprises the ring blocker device associated with the POTS telephone terminal equipment processing the telephone call by:
(i) blocking a first power ringing burst of the telephone call from reaching the POTS telephone terminal equipment;
(ii) capturing and storing the caller ID information of the telephone call present in a silent interval between the first power ringing burst and a subsequent second power ringing burst;
(iii) allowing the second power ringing burst of the telephone call to pass to the POTS telephone terminal equipment when the telephone call is not ended by the call blocking service; and
(iv) transmitting the caller ID information captured and stored in step (ii) to the POTS telephone terminal equipment after the second power ringing burst to enable the caller ID information to be displayed to a user of the POTS telephone terminal equipment.

2. The method of claim 1, wherein step (ii) comprises demodulating an analog signal carrying the caller ID information to recover digital caller ID information, and step (iv) comprises remodulating the recovered digital caller ID into an analog signal carrying the caller ID information.

3. The method of claim 1, wherein steps (ii) and (iv) are performed without demodulating an analog signal carrying the caller ID information.

4. The method of claim 1, wherein step (i) further comprises blocking the caller ID information of the telephone call present in the silent interval between the first power ringing burst and the second power ringing burst from reaching the POTS telephone terminal equipment.

5. The method of claim 1, wherein capturing and storing the caller ID information in step (ii) comprises recording an analog caller ID information signal containing the caller ID information present in the silent interval between the first power ringing burst and the second power ringing burst.

6. The method of claim 5, wherein transmitting the caller ID information in step (iv) comprises replaying a recorded analog caller ID information signal to the POTS telephone terminal equipment.

7. The method of claim 1, further comprising providing a visual indication in the ring blocker device to indicate to the user when the first power ringing burst of the telephone call is being blocked.

8. The method of claim 1, wherein the ring blocker device presents a DC resistance of at least 5 megohms for applied DC voltage up to 100 Vdc across the analog telephone line connected to the ring blocker device for receiving the telephone call.

9. The method of claim 8, wherein the ring blocker device is at least partially powered by an internal battery.

10. The method of claim 8, wherein the ring blocker device is powered entirely by the POTS telephone line.

11. The method of claim 1, wherein analyzing the caller ID information of the telephone call by the call blocking service to determine if the telephone call is unwanted comprises determining if the caller ID information of the telephone call is on a stored blacklist.

12. A ring blocker device associated with Plain Old Telephone Service (POTS) telephone terminal equipment for processing a telephone call directed to the POTS telephone terminal equipment, the telephone call including caller identification (caller ID) information and being received simultaneously at the ring blocker device and a call blocking service analyzing the caller ID information of the telephone call to determine if the telephone call is unwanted and ending the telephone call if the telephone call is determined to be unwanted, the ring blocker device comprising:
a telephone line input port for receiving the telephone call;
a telephone line output port connectable to the POTS telephone terminal equipment; and
at least one processor for processing the telephone call received at the telephone line input port, the at least one processor being configured to:
(i) block a first power ringing burst of the telephone call from reaching the POTS telephone terminal equipment;
(ii) capture and store the caller ID information of the telephone call present in a silent interval between the first power ringing burst and a subsequent second power ringing burst;
(iii) allow the second power ringing burst of the telephone call to pass to the POTS telephone terminal equipment from the telephone line output port when the telephone call is not ended by the call blocking service; and
(iv) transmit the caller ID information captured and stored in step (ii) to the POTS telephone terminal equipment through the telephone line output port after the second power ringing burst to enable the caller ID information to be displayed to a user of the POTS telephone terminal equipment.

13. The ring blocker device of claim 12, wherein step (ii) comprises demodulating an analog signal carrying the caller ID information to recover the encoded digital caller ID information, and step (iv) comprises re-modulating the recovered digital caller ID information into an analog signal that carries the caller ID information.

14. The ring blocker device of claim 12, wherein steps (ii) and (iv) are performed without demodulating an analog signal carrying the caller ID information.

15. The ring blocker device of claim 12, wherein step (i) further comprises blocking the caller ID information of the telephone call present in the silent interval between the first power ringing burst and the second power ringing burst from reaching the POTS telephone terminal equipment.

16. The ring blocker device of claim 12, wherein capturing and storing the caller ID information in step (ii) comprises recording an analog caller ID information signal containing the caller ID information present in the silent interval between the first power ringing burst and the second power ringing burst.

17. The ring blocker device of claim 16, wherein transmitting the caller ID information in step (iv) comprises replaying a recorded analog caller ID information signal to the POTS telephone terminal equipment.

18. The ring blocker device of claim 12, further comprising a visual indicator in the ring blocker device to indicate to the user when the first power ringing burst of the telephone call is being blocked.

19. The ring blocker device of claim 12, wherein the ring blocker device presents a DC resistance of at least 5 megohms for applied DC voltage up to 100 Vdc across the analog telephone line connected to the ring blocker device for receiving the telephone call.

20. The ring blocker device of claim 12, wherein the ring blocker device is powered at least partially by an internal battery.

21. The ring blocker device of claim 12, wherein the ring blocker device is powered entirely by the POTS telephone line.

22. The ring blocker device of claim 12, wherein the call blocking service determines if the telephone call is unwanted by determining if the caller ID information of the telephone call is on a stored blacklist.

23. A method of processing a telephone call to Plain Old Telephone Service (POTS) telephone terminal equipment, the telephone call including caller identification (caller ID) information, the method comprising the steps of:
(a) receiving the telephone call simultaneously at a call blocking service and a ring blocker device associated with the POTS telephone terminal equipment;
(b) analyzing the caller ID information of the telephone call by the call blocking service to determine if the telephone call is unwanted, and ending the telephone call if the telephone call is determined to be unwanted; and
(c) processing the telephone call by the ring blocker device associated with the POTS telephone terminal equipment by:
(i) blocking a first power ringing burst of the telephone call from reaching the POTS telephone terminal equipment;
(ii) capturing and storing the caller ID information of the telephone call present in a silent interval between the first power ringing burst and a subsequent second power ringing burst;
(iii) allowing the second power ringing burst of the telephone call to pass to the POTS telephone terminal equipment when the telephone call is not ended by the call blocking service; and
(iv) transmitting the caller ID information captured and stored in step (ii) to the POTS telephone terminal equipment after the second power ringing burst to enable the caller ID information to be displayed to a user of the POTS telephone terminal equipment.

24. A method of processing a telephone call to Plain Old Telephone Service (POTS) telephone terminal equipment, the telephone call including caller identification (caller ID) information, the telephone call being simultaneously received at a call blocking service and a ring blocker device associated with the POTS telephone terminal equipment, wherein the call blocking service analyzes the caller ID information of the telephone call to determine if the telephone call is unwanted and ends the telephone call if the telephone call is determined to be unwanted, wherein the method comprises the ring blocker device associated with the POTS telephone terminal equipment processing the telephone call by blocking a first power ringing burst of the telephone call from reaching the POTS telephone terminal equipment,
wherein the ring blocker device presents a DC resistance of at least 5 megohms for applied DC voltage up to 100 Vdc across the analog telephone line connected to the ring blocker device for receiving the telephone call, and
wherein the ring blocker device is at least partially powered by an internal battery.

25. A method of processing a telephone call to Plain Old Telephone Service (POTS) telephone terminal equipment, the telephone call including caller identification (caller ID) information, the telephone call being simultaneously received at a call blocking service and a ring blocker device associated with the POTS telephone terminal equipment, wherein the call blocking service analyzes the caller ID information of the telephone call to determine if the telephone call is unwanted and ends the telephone call if the telephone call is determined to be unwanted, wherein the method comprises the ring blocker device associated with the POTS telephone terminal equipment processing the telephone call by blocking a first power ringing burst of the telephone call from reaching the POTS telephone terminal equipment,
wherein the ring blocker device presents a DC resistance of at least 5 megohms for applied DC voltage up to 100 Vdc across the analog telephone line connected to the ring blocker device for receiving the telephone call, and
wherein the ring blocker device is powered entirely by the POTS telephone line.
